(19) United States
(12) Patent Application Publication
(10) Pub. No.: US 2004/0051894 A1
(43) Pub. Date: Mar. 18, 2004

(54) Portable input scanning device in communication with a multi-function document services machine

(75) Inventors: Richard Gillam, Hemel Hempstead (GB); Ian Burdon, Letchworth (GB)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/244,574

(22) Filed: Sep. 16, 2002

(51) Int. Cl. G06F 3/12; H04B 7/00

(52) U.S. Cl. 358/1.13; 358/1.15; 455/41.3; 455/66.1

(57) ABSTRACT

A multi-function document machine, such as a combined printer-copier-scanner-facsimile, accepts image data from one or more remote image input devices. Each image input device includes recording means, such as a digital camera or hand-held scanner, and sending means, such as a wireless transmitter. Image data recorded by the image input device is sent to the machine along with an instruction, such as to print or retain the image data. Image data received into the machine is merged into the regular job queue of the machine, alongside conventional print, copy, and scan jobs.

### TECHNICAL FIELD

The present invention relates to multi-function office equipment, such as a single machine with copier, printer, facsimile, and scan-to-file functions, and a portable or wireless input scanning device which can be associated with such equipment.

### BACKGROUND

Recently “multi-function” office equipment has become familiar in offices. Whereas, previously, functions such as copying, printing, and facsimile transmission have been performed by single dedicated copiers, printers, and facsimiles respectively, a multi-function machine is typically capable of providing all such functions and more in a single machine. Typically such a multi-function machine includes a single print engine, which can serve to output copies, prints, or received facsimiles; as well as a single input scanner which can serve to record data form original images for use in copying, facsimile transmission, and retention of input image data to a predetermined location in a computer memory (“scan-to-file”). Such multi-function machines are typically connected to data networks, such as the Internet, for exchange of both image data and associated operational instructions. Also, such machines, particularly those including high-speed printing engines, tend to be large and heavy.

The present disclosure is directed to systems by which input scanning of original images, such as from a device which reads images from hard-copy documents, or a digital camera, can be performed remotely from a multi-function machine. The multi-function machine, which can include more typical office functions such as copying and printing from desktop computers, accepts the image data and then performs desired functions thereon.

### DESCRIPTION OF THE PRIOR ART

U.S. Pat. No. 4,684,998 discloses an input scanner configured to record image data from a non-flat original, such as an open book. A head having photosensors therein is moved manually over the original.

U.S. Pat. No. 4,819,083 discloses a hand-held image scanner in which a photosensor array is manually moved relative to an image to be scanned. The device includes an on-board memory and editing device, including editing keys.

U.S. Pat. No. 4,943,868 discloses an image data recording and filing apparatus. The apparatus includes a portion, including photosensors, for recording images, and a portion including a memory for retaining image data and also entering, through a small keyboard, data by which data which is recorded at a particular time can be later identified.

U.S. Pat. No. 5,278,673 discloses a hand-held device for recording original images, such as from business cards, and retaining and displaying such images as desired. The device includes an encoding roll for coordinating the motion of the recording device with incoming image data when the device is manually rolled against the image to be recorded.

U.S. Pat. No. 5,920,401 discloses a compact input scanning device which can use ambient light as a light source. The scanner can be used as a facsimile device by providing telephone connections.

U.S. Pat. No. 5,355,146 discloses a hand-held device which can function both as a computer pointing device, or mouse, and as a scanner from recording images such as from printed books.

U.S. Pat. No. 6,067,112 discloses a system by which the position of an electronic camera relative to a document can be recorded and used to enhance document-intensive functions such as copying. With such a system, a hand-held camera can be used reliably for scanning image data such as text in a useful way.

U.S. Pat. No. 6,144,997 discloses a system for accessing and distributing electronic documents, in which a hard-wired network including multi-function machines further includes a set of personal, hand-held IR-based devices. Users, each having an IR-based device, transmit tokens symbolic of documents available within the network.

U.S. Pat. No. 6,377,764 discloses an architecture for office equipment, such as a multi-function machine, in which separate modules, such as the paper supply, input scanner, and finisher communicate with a central control system through wireless means.

### SUMMARY OF THE INVENTION

According to one aspect of the present invention, there is provided a method of operating a document machine, the document machine including a job queue and a transceiver. An image input device is provided, the image input device including an instruction pad for accepting instructions from a user, and a transmitter. Image data is recorded with the recording means of the image input device. An instruction is entered on the instruction pad of the image input device, the instruction being related to a function to be carried out by the document machine. The image data and the instruction are sent to the document machine via the transmitter of the image input device. The image data and the instruction are accepted in the job queue of the document machine.

According to another aspect of the present invention, there is provided an image input device for use with a document machine, comprising means for accepting image data; an instruction pad for accepting an instruction from a user, the instruction relating to a desired action to be taken on the image data; and a transceiver for sending the image data and data associated with the instruction to a document machine capable of substantially taking the desired action on the image data.

According to another aspect of the present invention, there is provided an interface module for use in combination with a document machine, the document machine including a job queue for retaining data relating to a plurality of jobs to be processed by the document machine. A receiver receives image data and instructional data associated therewith from an image input device remote from the interface module. Means are provided for directing received image data and instructional data to the job queue for processing by the document machine.

### BRIEF DESCRIPTION OF THE DRAWINGS

FIG. 1 is a diagram showing the interaction among various multi-function document machines, such as printer-copier-fax-scanners, and image input devices.

FIG. 2 is a picture of an example image input device.

FIG. 3 is a simplified diagram of a basic multi-function machine, in combination with an interface module according to an embodiment of the present invention.

### DETAILED DESCRIPTION

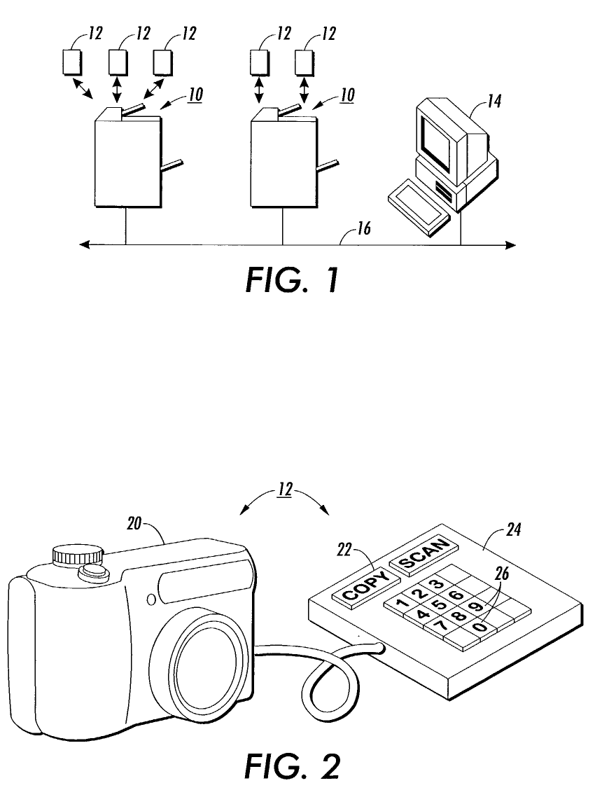

FIG. 1 is a diagram showing the interaction among various multi-function document machines such as printer-copier-fax-scanners (hereinafter “machines” 10) and image input devices (hereinafter “devices” 12) according to one embodiment of the present invention. Each machine 10 includes functions, embodied in hardware and software, for printing images on sheets, as well as accepting image data through a hard-copy input scanner; when an image is recorded with the input scanner and subsequently printed, the machine 10 acts as a copier. Further document related functions, such as facsimile transmission and reception, as well as sending data from scanned images to predetermined locations in the memory of an external computer such as 14 through a network 16, are also known. In one embodiment, each machine 10 is of a basic known type, and the functions relating to the invention are embodied in hardware and software which be ported to a machine such as 10.

For one machine 10 or each of a plurality of machines 10 on a network 16, each device 12 is adapted for communication of image and instructional data to the machine 10; each machine 10 treats such data substantially as any other type of data that must be processed, such as by printing/copying, faxing, or filing the data, in accordance with the instructions sent from a particular device 12. In short, each device 12 represents a source of image data and instructions for a selected machine 10, alongside other, more standard sources of data and instructions associated with the machine, such as for printing or copying documents.

FIG. 2 is a picture of an example device 12. Each device 12 includes at least three elements, a recorder 20, an instruction pad 22, and a transceiver 24 (which would be in the form of circuitry, software, etc. within the casing shown). In the illustrated embodiment, recorder 20 is in the form of a digital camera, which once again can be of a basic type currently available on the market, although more specialized types of recorder may be envisioned, as will be explained below. The function of recorder 20 is to record an image, either from markings, such as writing on a handwritten or printed document, or directly from reality, such as in a case where a physician photographs a patient or an insurance person photographs an automobile.

Although a digital camera of common configuration is shown in the Figure as recorder 20, the recorder can take any of a variety of forms depending on a desired task, such as: an electronic microscope, a CAT scanner, X-ray camera, or other medical device; a security camera; a badge reader; a fingerprint, retina, or other biometric reader; a currency reader or counterfeit detector; a medical or other diagnostic machine that outputs graphs, etc.

Instruction pad 22, which may include keys 26, as shown, or alternate devices such as a stylus-based pointing system, is a means by which a human user can associate some recorded image data with an instruction for a machine 10 as well as some identification data, as will be explained below. Transceiver 24, which in a practical embodiment typically includes both a transmitter and receiver, is an apparatus for conveying image data from recorder 20 and instructional and other data from instruction pad 22 to a machine 10; also, as needed for a typical implementation, the transceiver can receive “handshake” and other data from a control system associated with a machine 10, in order to carry out the transmission of data. In the embodiment, a wireless (IR or RF) mode of communication between a device 12 and machine 14 is contemplated; however, any means of communication, including a cable from a device 12 to a machine 10 such as through a USB port, can be envisioned. Also, commercial cell phone technology, suitably adapted, can be used for the transmission from the device 12 to the machine 10.

In operation, a user records image data with recorder 20 and also uses the instruction pad 22 to communicate a command, that is, what the user wishes to do with the data (typically, the user can give the command either just before or just after recording the data, e.g. taking the picture). In one case, the user touches the “copy” key: in this case, the image data from the recorded picture is transmitted through transceiver 24 to a selected machine 10. Devices 12 can be associated with individual machines 10, or, conceivably, a device 12 can in effect broadcast instructions and image data, such as through a factory or medical office, and a closest or otherwise most suitable machine 10 can accept the data and instruct other machines to ignore the data. The image data is received at the machine 10, and the machine 10 places the image data, and in response to the command from device 12, places the image data in its job queue, along with any other print or copy jobs that may have come from other sources, such as hard-wired personal computers or the machine's own local image scanner. In one embodiment, the job originating from a device 12 is treated indistinguishably from any other job handled by the machine 10. In effect, the device 12 acts as an auxiliary input scanner and user interface for the machine 10.

In a scan-to-file case, a user touches a key on instruction pad 22, and in response the transceiver 24 sends the image data and command to machine 10. The machine 10 in turn directs the image data to a predetermined location in memory, such as in computer 14. The predetermined location can be established in various ways, such as by the identification of the source device 12 and/or the time of transmission. Alternately or in addition, each human user having a device 12 can enter an account number, such as a patient number in the medical context, or a file number in the insurance context: the identification number is used when directing the image data to a file (already associated with the patient, policy number, etc.) in the external computer 14 so that it can be retrieved as desired later. Entry of such identification data is made through a numeric keyboard on the pad 22, or through a stylus-based pointing system, or by having the user first scan a barcode or equivalent with recorder 20, which causes all subsequent recorded images to be associated with the bar code, until a new barcode is scanned.

In a facsimile case, a user holding the device 12 can enter a fax number into the instruction pad 22 (either the destination fax number itself, or some key which is in effect a “fast-dial” key for a desired number), such number (or other code relating to the destination fax number) then being transmitted to a machine 10 along with the recorded image. When the machine 10 receives the image data and the fax number, the data is retained in a job queue, along with any other jobs associated with the machine 10 at the time. When the job reaches the front of the queue, the machine 10 initiates the fax transmission.

In the multi-function machine context, a machine 10 in effect maintains one or more queues of various jobs, such as print, copy, fax send and receive, and scan jobs. In one embodiment, image data and associated instructions from one or more devices 12 are simply entered into one or another appropriate queue within the control system alongside other jobs which are entered into the machine 10 in traditional ways. In this way, the large-scale efficiencies resulting from the shared resources within a multi-function machine are preserved in an office or library context.

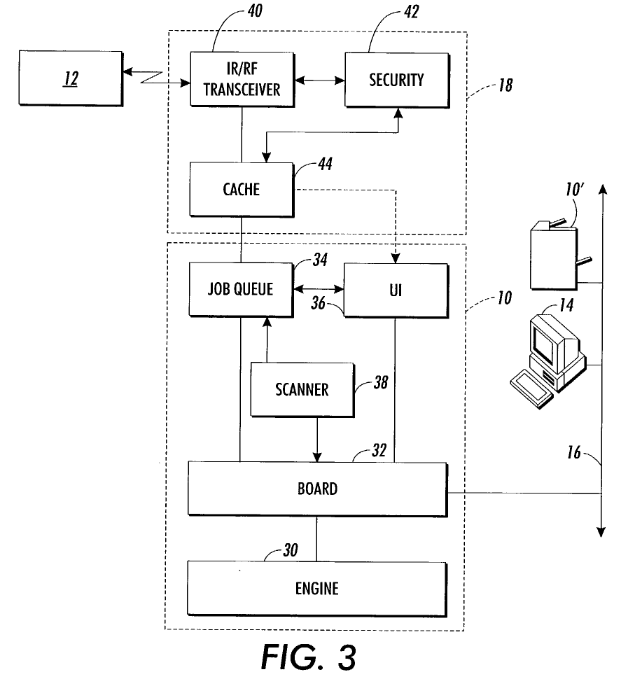

FIG. 3 is a simplified diagram of a basic copier-printer-facsimile-scanner machine 10 as would be modified according to an embodiment of the present invention. The basic machine 10, which can be an “off the shelf” product of pre-existing design, includes a print engine 30, which is directly controlled by software and hardware in a central control board 32, as is familiar in the art. Feeding into the board 32 is a job queue 34: as used herein, the term “job queue” refers to any combination of software and hardware which includes or controls a memory for retaining image and/or instructional data relating to jobs which are waiting to be printed, copied, faxed, sent to external memory in a computer such as 14, or otherwise processed by the machine.

For “walk-up” jobs, a standard multi-function document machine such as 10 includes a user interface (Ul) 36, which typically includes one or more hard keys and a touchscreen or similar dynamic interface; related to UI 36 would be the software operative on various client computers, such as for sending print jobs to the queue 34. The machine 10 further includes an input scanner 38, as is familiar in the art, for scanning image data from hard-copy originals; the resulting image data is queued in job queue 34 for processing according to instructions entered on UI 36.

According to this embodiment, augmenting the basic machine 10 is what is here called an “interface module” 18, which is installed on or otherwise associated with one or more machines 10; the module 18 could, for example, reside on a personal computer communicating with machine 10, or installed on a board in machine 10. Also, the module 18 can have a network address independent of that of the machine 10. Interface module 18 acts as a bridge between one or more devices 12 and the basic machine 10. As such, module 18 includes a transceiver 40, typically of an IR or RF variety, which accepts signals from one or more devices 12 within range. There may also be provided a security arrangement 42 to restrict wireless or other access to the module 18 to authorized devices 12, such as by checking for an identification code with incoming signals. Information obtained through the operation of the security arrangement 42 can also be associated with the incoming image data, such as by a determined identity of the sending device 12, and/or a time stamp of the incoming data. The time-stamp or the identity of the sending device can further be associated, within the interface module 18, with a destination location in memory of a computer 14, in a manner such as generally described above.

Once communication is established between a device 12 and module 18, image data along with associated instructions (copy, scan-to-file, fax, etc.) are briefly retained in a cache memory 44; at a suitable time, the image data from a device 12 is handed over to the job queue 34 of the basic machine, and the associated instruction is handed over to the Ul 36. After this point, the job received from the device 12 is in effect received alongside job data in job queue 34 of machine 10, such as regular print jobs from computers on the network, and scan or copy jobs from the regular scanner 38.

Features within an interface module 18 (or elsewhere, depending on the embodiment) can further be provided to facilitate an environment having multiple devices 12 and machines 10. For instance, if there are provided multiple machines 10, each of which is likely to receive a wireless signal from a particular device 12, an arrangement can be made whereby a “preferred” machine is programmed to perform the desired processing, such as printing or scanning, depending on the identity of the sending device 12; e.g., a doctor in an examining room may wish to have the pictures printed by the machine in his personal office within a large clinic. Other machines which may receive the same signal can be instructed not to process the image data; however, the other machines can be programmed to cache the received image data, such as in their respective cache memories 44, for a certain time or until certain conditions are met, such as the “preferred” machine 10 successfully processing the image data and in effect instructing other machines, such as on network 16 in FIG. 1, that they can overwrite the image data. Such an arrangement further facilitates a back-up system, whereby multiple machines 10 receive the data from a device 12, but only the preferred machine 10 is caused to process the image data; however, if after some amount of time the preferred machine 10 is determined to be somehow “down,” a second machine (here shown as 10′ in FIG. 3) on the network 16 is in effect instructed to process the image data cached therein, either by an explicit instruction from the preferred machine 10, or by implication, such as if a confirmation of successful processing is not received from the preferred machine.

Although the present embodiment of the present invention is largely resident on or associated with multi-function machines of a basically common digital-copier type, any or all elements of the invention can be resident on network servers associated with output devices such as printers.

1. A method of operating a document machine, the document machine including a job queue and a receiver, comprising:
providing an image input device, the image input device including an instruction pad for accepting instructions from a user, and a transmitter;
entering an instruction on the instruction pad of the image input device, the instruction being related to a function to be carried out by the document machine;
sending the image data and the instruction to the document machine via the transmitter of the image input device; and
accepting the image data and the instruction in the job queue of the document machine.

2. The method of claim 1, further comprising recording image data with recording means associated with the image input device.

3. The method of claim 2, wherein the recording means includes at least one from a group comprising a digital camera; a hand-held scanner; a medical device; a security camera; a badge reader; a biometric reader; a currency reader; a counterfeit detector; and a diagnostic machine that outputs graphs.

4. The method of claim 1, the document machine further including a print engine.

5. The method of claim 1, the document machine further including a local user interface.

6. The method of claim 1, the document machine further including a local input scanner.

7. The method of claim 1, the sending step including transmitting the image data in a wireless manner.

8. The method of claim 1, further comprising
the document machine directing the image data to a predetermined memory location.

9. The method of claim 8, further comprising
entering, at the image input device, identification data to associate with the image data.

10. The method of claim 9, the predetermined memory location being related to the identification data.

11. The method of claim 9, the step of entering the identification data including reading a code with the recording means.

12. The method of claim 1, wherein a plurality of image input devices are capable of sending image data and an instruction to the document machine.

13. The method of claim 1, wherein there are provided a plurality of document machines, and further comprising
sending an instruction from a first document machine to a second document machine not to process image data.

14. The method of claim 1, wherein there are provided a plurality of document machines, and further comprising
causing a second machine to process the image data if a first machine is determined to be unsuccessful in processing the image data.

15. An image input device for use with a document machine, comprising:
means for accepting image data;
an instruction pad for accepting an instruction from a user, the instruction relating to a desired action to be taken on the image data; and
a transmitter for sending the image data and data associated with the instruction to a document machine capable of substantially taking the desired action on the image data.

16. The device of claim 15, further comprising recording means for recording image data.

17. The device of claim 16, wherein the recording means includes at least one from a group comprising a digital camera; a hand-held scanner; a medical device; a security camera; a badge reader; a biometric reader; a currency reader; a counterfeit detector; and a diagnostic machine that outputs graphs.

18. The device of claim 15, the instruction pad including a key for instructing that the image data be printed by the document machine.

19. The device of claim 15, the instruction pad including a key for instructing that the image data be directed to a predetermined memory location by the document machine.

20. The device of claim 15, the instruction pad including a set of numerical keys.

21. The device of claim 15, the transmitter transmitting the image data in a wireless manner.

22. An interface module for use in combination with a document machine, the document machine including a job queue for retaining data relating to a plurality of jobs to be processed by the document machine, comprising:
a receiver for receiving image data and instructional data associated therewith from an image input device remote from the interface module; and
means for directing received image data and instructional data to the job queue for processing by the document machine.

23. The module of claim 22, wherein the receiver receives at least one of the image data and the instructional data in a wireless manner.

24. The module of claim 22, wherein the job queue of the document machine is capable of receiving image data and instructional data from a source other than the interface module, and the directing means directs received image data and instructional data to the job queue alongside image data from the source.

25. The module of claim 22, wherein the document machine includes a local input scanner, and the directing means directs received image data and instructional data to the job queue alongside image data from the local input scanner.

26. The module of claim 22, further comprising security means for controlling access to the interface module by an image input device.

27. The module of claim 22, wherein the instructional data comprises at least one instruction from a group comprising facsimile send, print, and scan to a predetermined location in a memory.

28. The module of claim 22, further comprising means for associating a transmission time with the received image data.

29. The module of claim 28, further comprising means for associating the transmission time with a predetermined location in a memory to send the received image data.

30. The module of claim 22, further comprising means for associating a sender identification with the received image data.

31. The module of claim 30, further comprising means for associating the sender identification with a predetermined location in a memory to send the received image data.

32. The module of claim 22, further comprising means for instructing another document machine not to process received image data.

33. The module of claim 22, further comprising means for instructing another document machine to process received image data.
